(19) United States
(12) Patent Application Publication
(10) Pub. No.: US 2020/0053232 A1
(43) Pub. Date: Feb. 13, 2020

(54) IMAGE FORMING APPARATUS THAT CORRECTS MISSPELLING

(71) Applicant: KYOCERA Document Solutions Inc., Osaka (JP)

(72) Inventor: John Macler CUAMBOT, Osaka (JP)

(73) Assignee: KYOCERA Document Solutions Inc., Osaka (JP)

(21) Appl. No.: 16/519,704

(22) Filed: Jul. 23, 2019

(30) Foreign Application Priority Data
Aug. 10, 2018 (JP) 2018-151841

(51) Int. Cl. H04N 1/00

(52) U.S. Cl. CPC H04N 1/00222; H04N 1/00169; H04N 1/00206

(57) ABSTRACT

An image forming apparatus includes a data input unit, an instruction input unit, an image forming unit, a display unit, and a controller. The controller causes the display unit to display, when first document data is received through the data input unit, and character strings expressed by the first document data include a first character string containing a misspelling, a second character string that may possibly be substituted for the first character string. The controller also generates, upon receipt of an instruction to select the second character string through the instruction input unit, second document data on a basis of the first document data, by substituting the first character string in the character strings expressed by the first document data, with the second character string selected.

### INCORPORATION BY REFERENCE

This application claims priority to Japanese Patent Application No. 2018-filed on Aug. 10, 2018, the entire contents of which are incorporated by reference herein.

### BACKGROUND

The present disclosure relates to an image forming apparatus, and more particularly to a technique to correct document data.

Existing image forming apparatuses include those configured to display a preview image based on image data. For example, some digital multifunction peripherals are configured to display a preview image, for example when performing a printing operation, or when transmitting or receiving image data via the internet.

### SUMMARY

The disclosure proposes further improvements of the foregoing technique. In an aspect, the disclosure provides an image forming apparatus including a data input unit, an instruction input unit, an image forming unit, a display unit, and a controller. The data input unit receives an input of first document data. The instruction input unit receives an instruction inputted by a user. The image forming unit forms an image on a recording medium. The controller includes a processor, and decides, when the processor executes a correction control program, whether character strings expressed by the first document data, received through the data input unit, include a first character string containing a misspelling. The controller causes the display unit to display, when the first document data is received through the data input unit, and the character strings expressed by the first document data include the first character string containing the misspelling, a second character string that may possibly be substituted for the first character string. The controller further generates, upon receipt of an instruction to select the second character string through the instruction input unit, second document data on a basis of the first document data, by substituting the first character string in the character strings expressed by the first document data, with the second character string selected.

### BRIEF DESCRIPTION OF THE DRAWINGS

FIG. 1 is a perspective view showing an appearance of an image forming apparatus according to an embodiment of the disclosure.

FIG. 2 is a block diagram showing an internal configuration of the image forming apparatus according to the embodiment of the disclosure.

FIG. 3 is a flowchart showing a document data correction process.

FIG. 4 is another flowchart showing the document data correction process.

FIG. 5 is a schematic drawing showing an example of an external memory screen.

FIG. 6 is a schematic drawing showing an example of a first selection screen.

FIG. 7 is a schematic drawing showing an example of a correction screen.

FIG. 8 is a schematic drawing showing an example of a confirmation screen.

FIG. 9 is a schematic drawing showing an example of a second selection screen.

FIG. 10 is a schematic drawing showing an example of an input screen.

### DETAILED DESCRIPTION

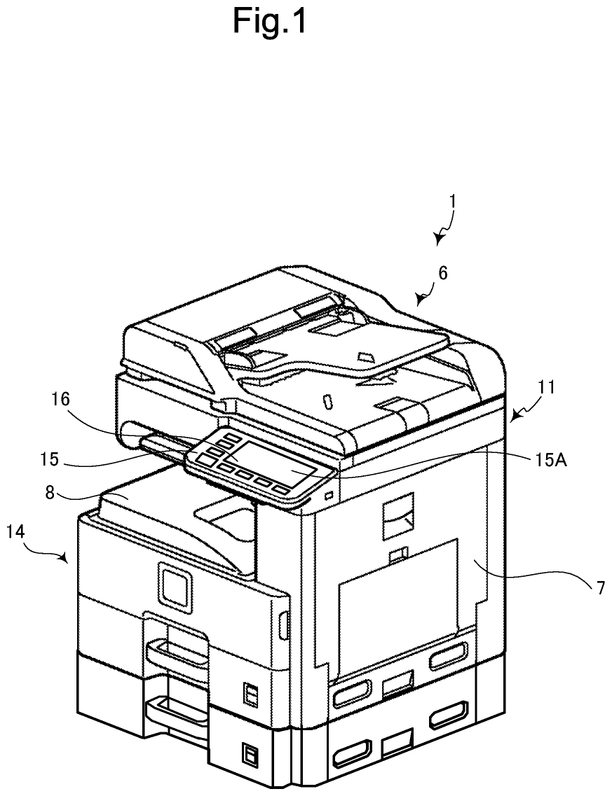

Hereafter, an image forming apparatus according to an embodiment of the disclosure will be described, with reference to the drawings. FIG. 1 is a perspective view showing an appearance of the image forming apparatus according to the embodiment of the disclosure. Referring to FIG. 1, the image forming apparatus 1 is a multifunction peripheral having a plurality of functions such as a facsimile function, a copying function, a printing function, and a scanning function.

In this embodiment, the image forming apparatus 1 is configured to generate, when character strings expressed by first document data to be printed include a first character string containing a misspelling, second document data in which the first character string in the character strings expressed by the first document data is substituted with a second character string selected by the user. The mentioned function will hereinafter be referred to as “document data correction”.

In this embodiment, the first document data includes character strings containing, for example, a word, a phrase, or a sentence. The type of the first document data is not specifically limited, provided that a character string to be analyzed by a known spell check function can be extracted from the document data. The first document data can be typically exemplified by document data generated with word processing software, such as Microsoft Word (registered trademark).

The image forming apparatus 1 shown in FIG. 1 includes, inside a casing 7, a plurality of components for realizing various functions of the image forming apparatus 1. For example, an image reading unit 11, an image forming unit 12, a fixing unit 13, and a paper feed unit 14 are provided inside the casing 7.

The image reading unit 11 is an automatic document feeder (ADF) including a document transport unit 6 that transports source documents, and a scanner that optically reads the document transported by the document transport unit 6, or placed on a contact glass. The image reading unit 11 emits light from a light emitter to the document, and receives the reflected light with a charge-coupled device (CCD), to thereby read the image on the document and generate image data.

The image forming unit 12 includes a, photoconductor drum, a charging device, an exposure device, a developing device, and a transfer device. The image forming unit 12 forms an image based on a toner image, on a recording sheet delivered from the paper feed unit 14, according to the image data generated by the image reading unit 11, image data received from a personal computer (PC) 23 connected via a network, or image data received from another facsimile machine.

The fixing unit 13 heats and presses the recording sheet, on which the toner image has been formed by the image forming unit 12, thereby fixing the toner image onto the recording sheet. The recording sheet with the toner image fixed thereon by the fixing unit 13 is discharged to an output tray 8.

The paper feed unit 14 draws out the recording sheets stocked in a paper cassette or placed on a manual bypass tray, one by one with a pickup roller, and delivers the recording sheet to the image forming unit 12.

The image forming apparatus 1 includes an operation unit 15. The operation unit 15 is operated by the user, to input instructions with respect to the functions that the image forming apparatus 1 is configured to perform. The operation unit 15 includes, as an example of hard keys, a start key for instructing the execution of the function. The operation unit 15 also includes a display unit 16. The display unit 16 includes, for example, a liquid crystal display. The display unit 16 displays various types of screens related to the functions that the image forming apparatus 1 is configured to perform. The operation unit 15 includes a touch panel 15A overlaid on the display unit 16. The operation unit 15 exemplifies the instruction input unit in What is claimed is.

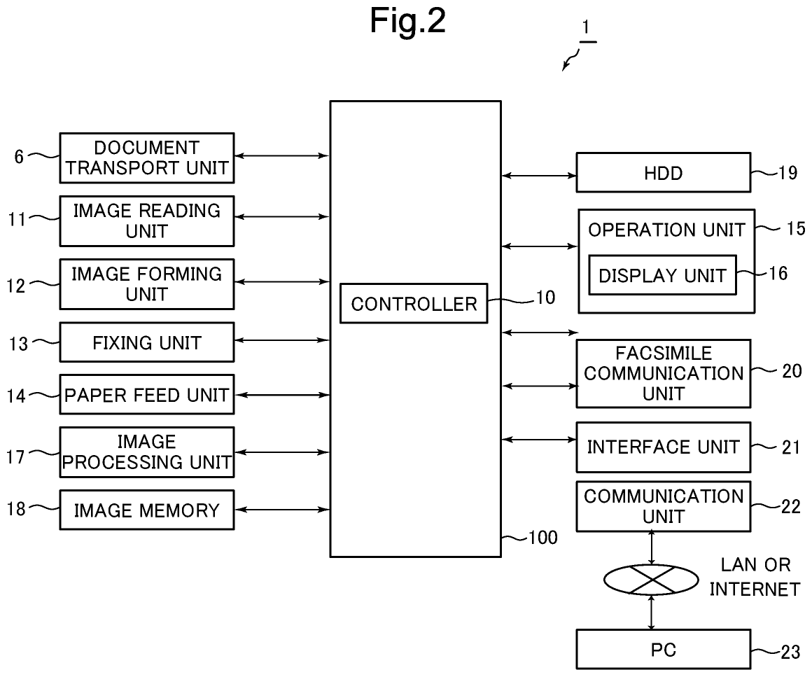

FIG. 2 is a block diagram showing an internal configuration of the image forming apparatus according to the embodiment of the disclosure. As shown in FIG. 2, the image forming apparatus 1 includes a control unit 100. The control unit 100 includes a processor, a random-access memory (RAM), and a read-only memory (ROM). The processor may be, for example, a central processing unit (CPU), a microprocessing unit (MPU), or an application specific integrated circuit (ASIC). The control unit 100 acts as a controller 10 when the processor executes a control program stored in the built-in ROM or a hard disk drive (HDD) 19.

The control unit 100 is electrically connected to the document transport unit 6, the image reading unit 11, the image forming unit 12, the fixing unit 13, the paper feed unit 14, the operation unit 15, an image processing unit 17, an image memory 18, the HDD 19, a facsimile communication unit 20, an interface unit 21, and a communication unit 22.

The controller 10 controls the overall operation of the image forming apparatus 1. To be more detailed, the controller 10 controls the operation of the functional units of the image forming apparatus 1, and the communication with an external device such as a PC 23, connected via a network.

The image processing unit 17 processes an image as required, with respect to the image data generated by the image reading unit 11.

The image memory 18 includes a region where the image data to be printed, generated by the image reading unit 11, is temporarily stored.

The HDD 19 is a large-capacity storage device in which various types of data, including the image data generated by the image reading unit 11, is stored. The HDD 19 also contains control programs for realizing the basic functions of the image forming apparatus 1. The HDD 19 exemplifies the storage unit in What is claimed is.

The HDD 19 contains a correction control program for executing the document data correction according to this embodiment. The processor acts, by operating in accordance with the correction control program, as the controller 10 to execute the document data correction. The correction control program is one of the control programs.

Here, the controller 10 may be constituted of hardware circuits to perform the operations, instead of being realized on the basis of the computer program. Alternatively, the controller 10 may be constituted of two or more control units.

In this embodiment, the controller 10 is configured to analyze character strings expressed by the first document data thereby deciding whether the character strings include a first character string containing a misspelling, and cause the display unit 16 to display a second character string that may possibly be substituted for the first character string. For this purpose, the HDD 19 contains an analysis control program for realizing a known spell check function, and a database including vocabularies of each language. The analysis control program is one of the control programs.

The facsimile communication unit 20 realizes connection to the public telephone circuit, to transmit and receive the image data via the public telephone circuit.

The interface unit 21 includes, for example, a universal serial bus (USB) port, and is compatible with a hot plug use. The interface unit 21 exemplifies the data input unit in What is claimed is.

The communication unit 22 includes a communication module such as a local area network (LAN) board. The image forming apparatus 1 can perform data communication with an information processing device such as the PC 23 on a network, through the communication unit 22. The communication unit 22 exemplifies the data input unit in What is claimed is.

The functional units of the image forming apparatus 1 are connected to a power source, to operate with the power supplied from the power source.

### Operation

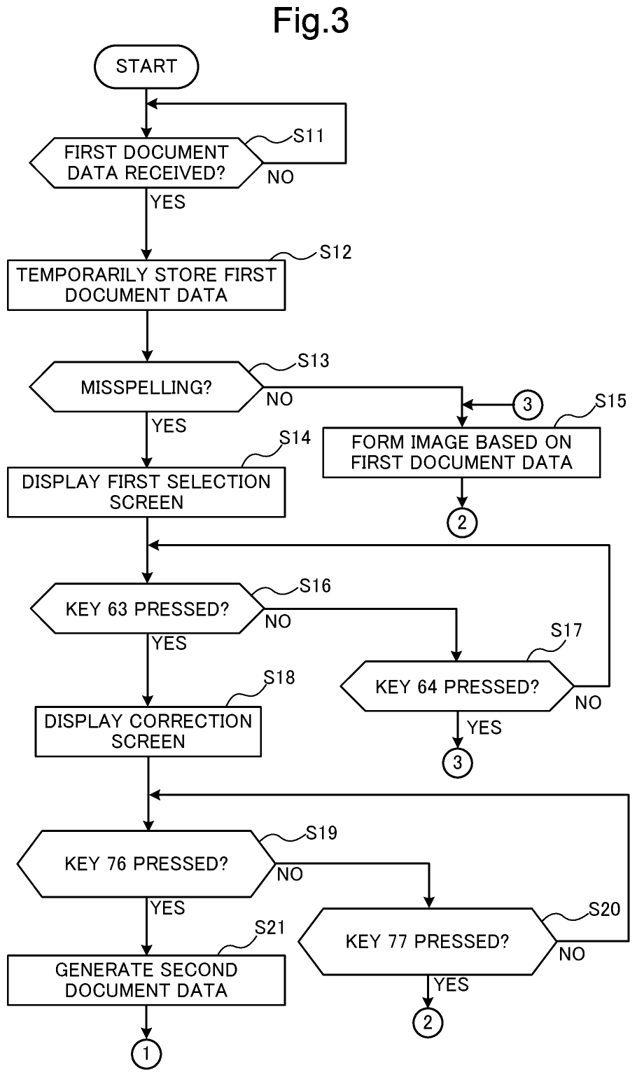

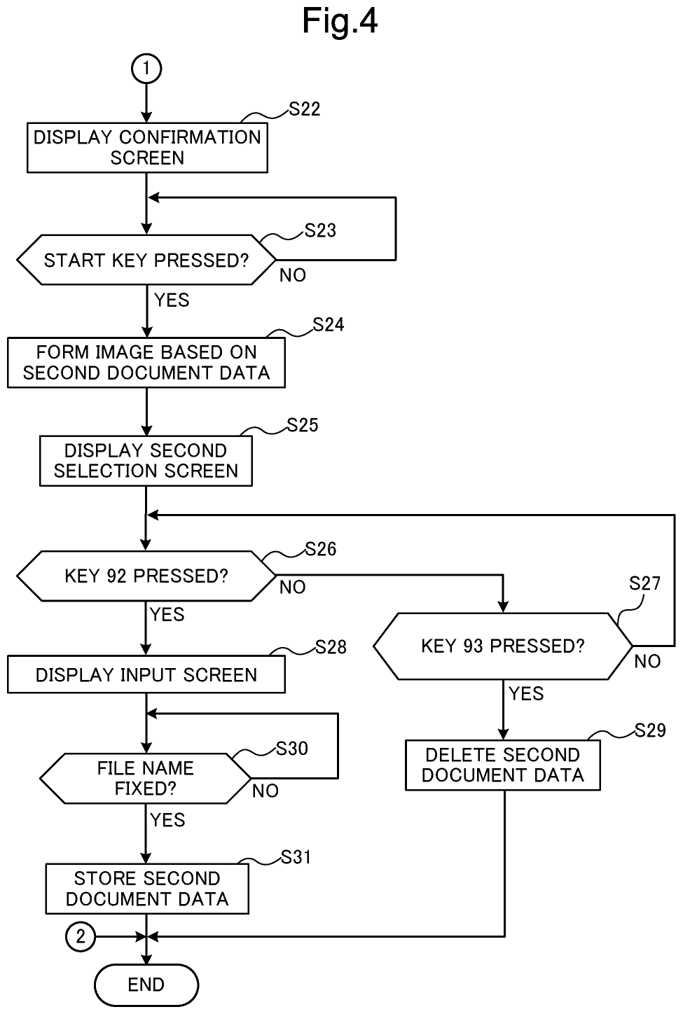

FIG. 3 and FIG. 4 are flowcharts each showing the process of the document data correction. Hereunder, the control process according to the correction control program for performing the document data correction will be described, along with the operation performed by the image forming apparatus 1. The correction control program is carried out when the power of the image forming apparatus 1 is turned on.

For the description given below, it will be assumed that power of the image forming apparatus 1 is turned on. In this case, a home screen for selecting one of the plurality of functions that the image forming apparatus 1 can execute is displayed on the display unit 16. Referring to FIG. 3, the controller 10 is standing by for receiving the first document data (NO at step 11).

(1) When First Document Data is Inputted Through Interface Unit 21

It will be assumed that the user has made up the first document data by a personal computer, for example using word processing software such as Microsoft Word (registered trademark), and stored the document in a USB memory, under the file name “Document 1.doc”. It will also be assumed that the first document data includes character strings representing a sentence “The qiuck brown fox jumps over the layz dog”.

The user connects the USB memory in which the first document data is stored, to the interface unit 21. The controller 10 causes the display unit 16, upon recognizing that the USB memory has been connected to the interface unit 21, to display an external memory screen for urging the user to select the data file to be printed, and input a printing instruction.

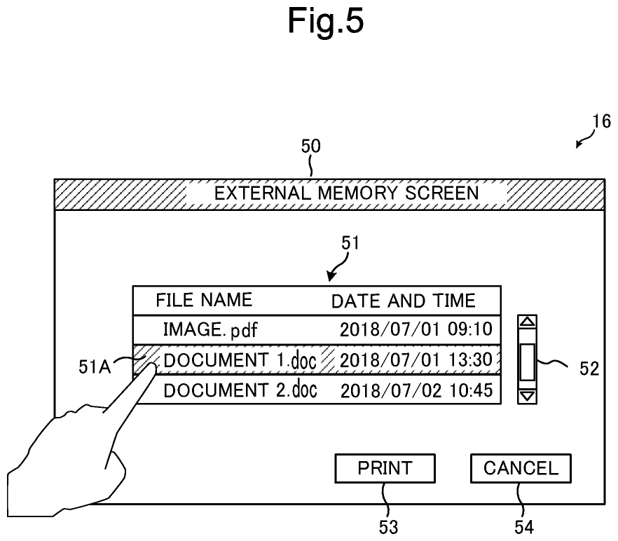

FIG. 5 illustrates an example of the external memory screen. As shown in FIG. 5, the external memory screen 50 includes a region 51, where the file name and the date and time of creation of each of the data files stored in the USB memory are displayed. The external memory screen 50 also includes a scroll bar 52, for changing the file name and the date and time of creation to be displayed in the region 51, when the file name and the date and time of creation of all the data files stored in the USB memory are unable to be displayed in the region 51.

The external memory screen 50 also includes a key 53 for inputting the printing instruction, and a key 54 for inputting an instruction to cancel the display of the external memory screen 50, which are soft keys.

In view of the external memory screen 50, the user selects the data file to be printed, by touching a region 51A where the file name and the related data of the first document data are displayed, and presses the key 53. Referring to FIG. 3, when the touch panel 15A detects that the key 53 has been pressed, the controller 10 decides that the first document data has been received (YES at step 11). Then the controller 10 retrieves the first document data in the USB memory through the interface unit 21, and temporarily stores the first document data retrieved, in the image memory 18 or HDD 19 (step S12).

The controller 10 analyzes the character strings expressed by the first document data using a known spell check function, and decides whether the character strings contain any misspelling (step S13). In this example, the controller 10 decides that words “qiuck” and “layz” are misspelled, in the character strings expressed by the first document data, on the basis of the analysis result (YES at step S13), and causes the display unit 16 to display a first selection screen for urging the user to select whether to correct the misspelling (step S14).

In the case where there is no misspelling in the character strings expressed by the first document data, the controller 10 decides that there is no misspelling on the basis of the analysis result (NO at step S13), and causes the image forming unit 12 to form an image based on the first document data, on the recording sheet (step S15). In this case, the image formed on the recording sheet does not contain any misspelling. After the image based on the first document data is formed, the controller 10 finishes the document data correction. After finishing the document data correction, the controller 10 causes the display unit 16 to again display the home screen.

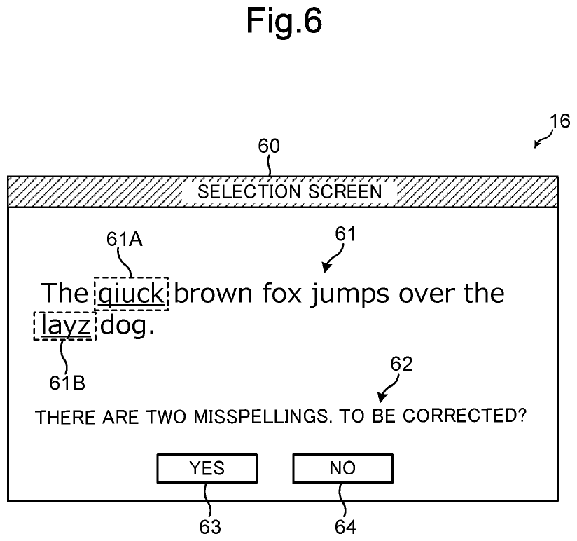

FIG. 6 illustrates an example of the first selection screen. As shown in FIG. 6, the first selection screen 60 includes a region 61, where character strings expressed by the first document data are displayed. In this example, the controller 10 has caused the display unit 16 to display character strings representing a sentence “The qiuck brown fox jumps over the layz dog”, in the region 61. The character strings include first character strings 61A and 61B, each of which is misspelled. The first character string 61A represents the word “qiuck”. The first character string 61B represents the word “layz”. The controller 10 causes the display unit 16 to display the first character strings 61A and 61B in a highlighted form, for example with an underline, or in a different color from the remaining character strings, for distinction from the remaining character strings.

The first selection screen 60 includes a message 62, to such an effect as “There are two misspellings. To be corrected?”. The first selection screen 60 includes a key 63 for inputting the instruction to correct the misspelling, and a key 64 for inputting the instruction to leave the misspelling uncorrected, which are soft keys. After the first selection screen 60 is displayed, the controller 10 stands by until the key 63 is pressed or until the key 64 is pressed (NO at step S16, NO at step S17).

Here, it will be assumed that the user has pressed the key 63, upon confirming the first selection screen 60. When the touch panel 15A detects that the key 63 has been pressed, the controller 10 decides that the instruction to correct the misspelling has been inputted (YES at step S16), and causes the display unit 16 to display a correction screen for correcting the misspelling (step S18).

In contrast, in the case where the user presses the key 64 without the intention to correct the misspelling, and the touch panel 15A detects that the key 64 has been pressed, the controller 10 decides that the instruction to leave the misspelling has been inputted (YES at step S17), and causes the image forming unit 12 to form the image based on the first document data, on the recording sheet (step S15). In this case, the image formed on the recording sheet includes the character strings “The qiuck brown fox jumps over the layz dog”, which still contain the misspellings. After the image based on the first document data is formed, the controller 10 finishes the document data correction. After finishing the document data correction, the controller 10 causes the display unit 16 to again display the home screen.

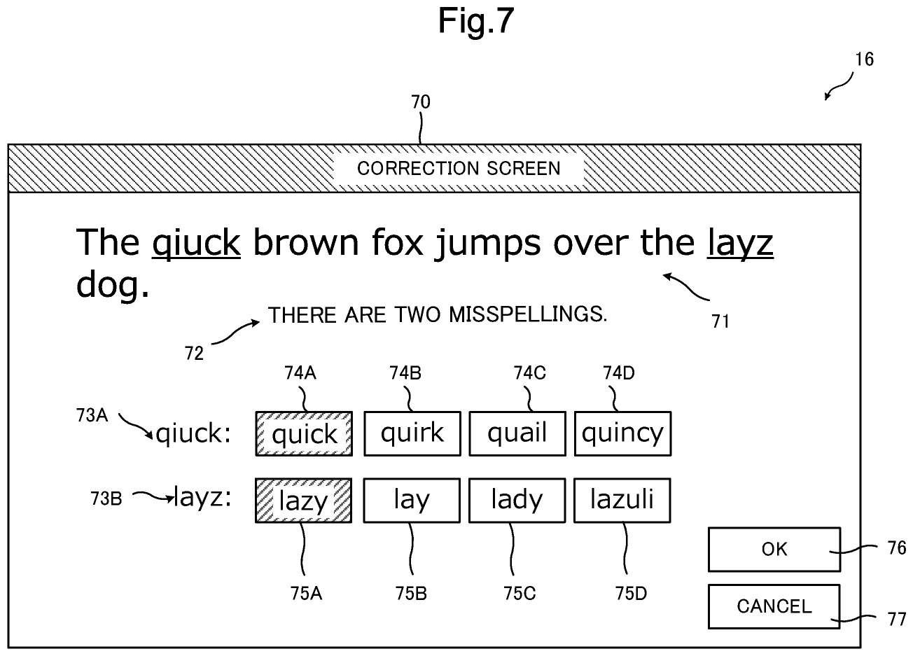

FIG. 7 illustrates an example of the correction screen. As shown in FIG. 7, the correction screen 70 includes a region 71, where character strings expressed by the first document data are displayed. Similarly to the display of the character strings in the region 61, the controller 10 causes the display unit 16 to display the first character strings containing the misspelling in a highlighted form in the region 71, for example with an underline, or in a different color from the remaining character strings, for distinction from the remaining character strings. The correction screen 70 also includes a message 72 to such an effect as “There are two misspellings”.

The correction screen 70 includes keys 74A, 74B, 74C, and 74D, which are soft keys, for selecting a second character string to be substituted for a first character string 73A representing a word “qiuck”. The controller 10 causes the display unit 16 to display the second character strings that may possibly be substituted for the first character string 73A, in the respective keys 74A, 74B, 74C, and 74D. In addition, the controller 10 causes the display unit 16 to display the keys 74A, 74B, 74C, and 74D in the order of likelihood of being selected by the user, for example in the order of similarity to the first character string 73A.

The criteria for deciding the order of similarity between the first character string and the second character string is not specifically limited. The similarity may be decided through general consideration on the basis of, for example, the number of the same letters in the first character string and the second character string, the ratio of the matching portion in the first character string and the second character string, a difference in overall length between the first character string and the second character string, and so forth.

In the illustrated example, the second character string representing a word “quick”, which is highest in similarity to the first character string 73A, is displayed in the key 74A. The second character string representing a word “quirk”, which is second highest in similarity to the first character string 73A, is displayed in the key 74B. The second character string representing a word “quail”, which is third highest in similarity to the first character string 73A, is displayed in the key 74C. The second character string representing a word “quincy”, which is lowest in similarity to the first character string 73A, is displayed in the key 74D. The controller 10 causes the display unit 16 to display the second character string in the key 74A in a highlighted form, for example in a different color, for distinction from the second character strings in the keys 74B, 74C, and 74D.

The correction screen 70 also includes keys 75A, 75B, 75C, and 75D, which are soft keys, for selecting a second character string to be substituted for a first character string 73B representing a word “layz”. The controller 10 causes the display unit 16 to display the second character strings that may possibly be substituted for the first character string 73B, in the respective keys 75A, 75B, 75C, and 75D. In addition, the controller 10 causes the display unit 16 to display the keys 75A, 75B, 75C, and 75D in the order of likelihood of being selected by the user, for example in the order of similarity to the first character string 73B.

In the illustrated example, the second character string representing a word “lazy”, which is highest in similarity to the first character string 73B, is displayed in the key 75A. The second character string representing a word “lay”, which is second highest in similarity to the first character string 73B, is displayed in the key 75B. The second character string representing a word “lady”, which is third highest in similarity to the first character string 73B, is displayed in the key 75C. The second character string representing a word “lazuli”, which is lowest in similarity to the first character string 73B, is displayed in the key 75D. The controller 10 causes the display unit 16 to display the second character string in the key 75A in a highlighted form, for example in a different color, for distinction from the second character strings in the keys 75B, 75C, and 75D.

Further, the correction screen 70 includes a key 76 for fixing the selection of the second character string, and a key 77 for inputting an instruction to cancel the display of the correction screen 70, which are soft keys. After the correction screen 70 is displayed, the controller 10 stands by until the key 76 is pressed or until the key 77 is pressed (NO at step S19, NO at step S20).

Here, it will be assumed that upon confirming the correction screen 70 the user has pressed the key 74A, to select the second character string representing the word “quick”, and the key 75A to select the second character string representing the word “lazy”, and then pressed the key 76.

When the touch panel 15A detects that the key 76 has been pressed, the controller 10 decides that the instruction to fix the selection of the second character string has been inputted (YES at step S19), and generates, on the basis of the first document data, second document data in which the first character string in the character strings expressed by the first document data is substituted with the second character string selected (step S21).

In the illustrated example, the controller 10 generates the second document data representing a sentence “The quick brown fox jumps over the lazy dog”, in which, out of the character strings in the first document data representing the sentence “The qiuck brown fox jumps over the layz dog”, the first character string “layz” is substituted with the second character string “lazy”, and the first character string “qiuck” is substituted with the second character string “quick”.

In contrast, in the case where the user presses the key 77 upon confirming the correction screen 70, and the touch panel 15A detects that the key 77 has been pressed, the controller 10 decides that an instruction to cancel the display of the correction screen 70 has been inputted (YES at step S20), and finishes the document data correction. After finishing the document data correction, the controller 10 causes the display unit 16 to again display the home screen.

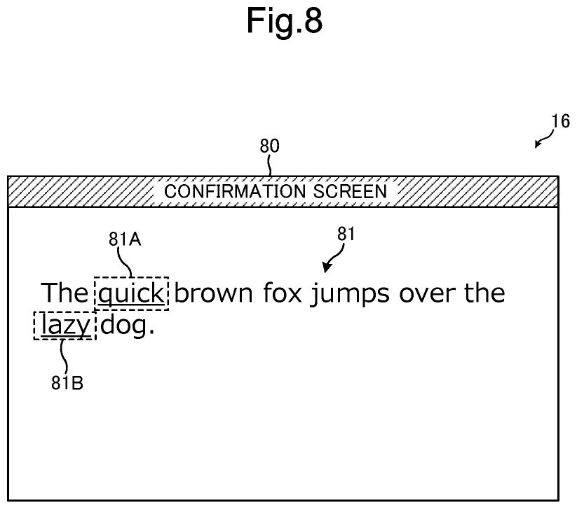

Referring now to FIG. 4, after generating the second document data, the controller 10 causes the display unit 16 to display a confirmation screen for confirming the corrected character string (step S22). FIG. 8 illustrates an example of the confirmation screen. As shown in FIG. 8, the confirmation screen 80 includes a region 81, where the character strings expressed by the second document data are displayed. In the illustrated example, the controller 10 causes the display unit 16 to display the character strings representing the sentence “The quick brown fox jumps over the lazy dog”, in the region 81. The controller 10 causes the display unit 16 to display second character strings 81A and 81B substituted for the first character strings in a highlighted form, for example with an underline, or in a different color from the remaining character strings, for distinction from the remaining character strings. After the confirmation screen 80 is displayed, the controller 10 stands by for a press of the start key provided in the operation unit 15 (NO at step S23).

Here, it will be assumed that the user has confirmed the confirmation screen 80, and pressed the start key, provided as a hard key in the operation unit 15, to instruct execution of the printing. Upon detecting that the start key has been pressed (YES at step S23), the controller 10 causes the image forming unit 12 to form an image based on the second document data on the recording sheet (step S24). Thus, the image containing the character strings “The quick brown fox jumps over the lazy dog”, now free from misspelling, is formed on the recording sheet.

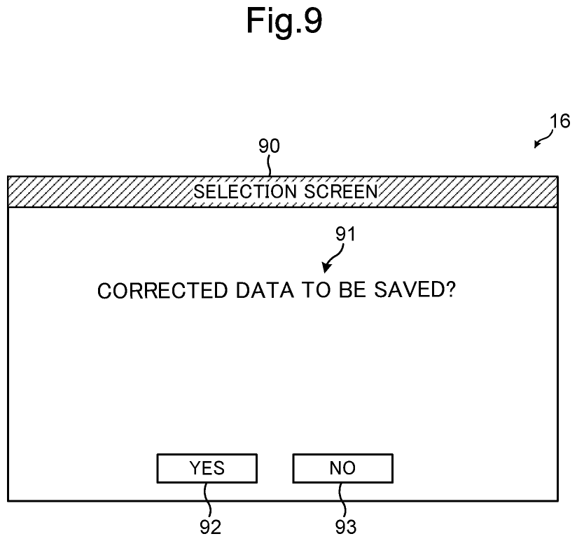

After the image based on the second document data is formed, the controller 10 causes the display unit 16 to display a second selection screen for selecting whether to save the second document data (step S25). FIG. 9 illustrates an example of the second selection screen. As shown in FIG. 9, the second selection screen 90 includes a message 91 to such an effect as “Corrected data to be saved?”.

The second selection screen 90 includes a key 92 for inputting an instruction to save the second document data, and a key 93 for instructing not to save the second document data, which are soft keys. After the second selection screen 90 is displayed, the controller 10 stands by until the key 92 is pressed or until the key 93 is pressed (NO at step S26, NO at step S27).

Here, it will be assumed that the user has pressed the key 92, with the intention to save the second document data. When the touch panel 15A detects that the key 92 has been pressed, the controller 10 decides that an instruction to save the second document data has been inputted (YES at step S26), and causes the display unit 16 to display an input screen for inputting a file name (step S28).

In contrast, in the case where the user presses the key 93 without the intention to save the second document data, and the touch panel 15A detects that the key 93 has been pressed, the controller 10 decides that the instruction not to save the second document data has been inputted (NO at step S27), and deletes the second document data temporarily stored in the image memory 18 or the HDD 19 (step S29). After the second document data is deleted, the controller 10 finishes the document data correction. After finishing the document data correction, the controller 10 causes the display unit 16 to again display the home screen.

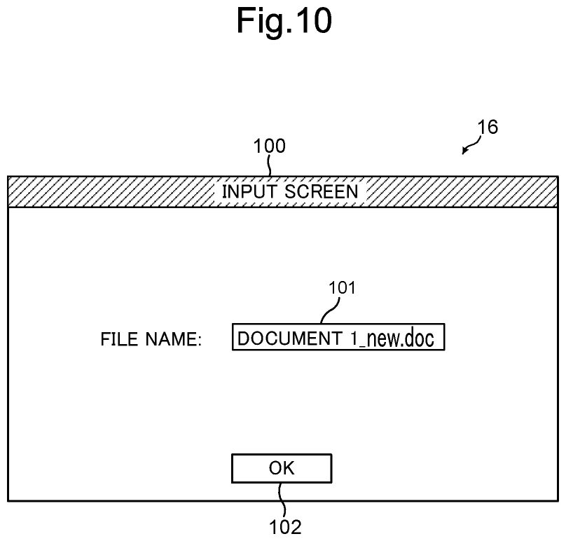

FIG. 10 illustrates an example of the input screen. As shown in FIG. 10, the input screen 100 includes a box 101, in which the file name of the second document data is to be inputted. At the time that the input screen has appeared, the controller 10 causes the display unit 16 to display the file name of the first document data as “Document 1.doc” in the box 101, as default. The input screen 100 includes a key 102, which is a soft key, for inputting an instruction to fix the file name shown in the box 101. After the input screen 100 is displayed, the controller 10 stands by for a press of the key 102 (NO at step S30).

Here, it will be assumed that, upon confirming the input screen 100, the user has inputted the file name of the second document data as “Document 1_new.doc” in the box 101 through the operation unit 15, and pressed the key 102. When the touch panel 15A detects that the key 102 has been pressed, the controller 10 decides that an instruction to fix the file name of the second document data has been inputted (YES at step S30), and stores the second document data with the file name thereof inputted in the box 101, in the USB memory connected to the interface unit 21 (step S31).

When the user presses the key 102 without changing the file name shown in the box 101 as default, the controller 10 overwrites the second document data on the first document data, and stores the second document data in the USB memory connected to the interface unit 21.

(2) When First Document Data is Inputted through Communication Unit 22

Hereunder, the operation performed by the image forming apparatus 1 when the first document data is inputted through the communication unit 22 will be described. However, the description of the same operation as that performed when the first document data is inputted through the interface unit 21 will not be repeated.

It will be assumed that the user has made up the first document data by the PC 23, for example using word processing software such as Microsoft Word (registered trademark), and stored the document in the HDD provided in the PC23, under the file name “Document 1.doc”. It will also be assumed that the first document data includes character strings representing a sentence “The qiuck brown fox jumps over the layz dog”.

When the user inputs, through the keyboard of the PC 23, an instruction to cause the image forming apparatus 1 to print an image based on the first document data, the controller in the PC 23 receives the instruction inputted, and transmits the first document data, along with the instruction to print the first document data, to the image forming apparatus 1.

Referring to FIG. 3, upon receipt of the first document data and the mentioned instruction transmitted from the PC 23 through the communication unit 22, the controller 10 decides that the first document data has been received (YES at step 11), and temporarily stores the first document data received through the communication unit 22, in the image memory 18 or the HDD 19 (step S12).

After step S12, the controller 10 performs the operation of step S13 to step S30, in a similar manner to the above

Here, it will be assumed that, upon confirming the input screen 100 shown in FIG. 10 after the controller 10 has finished the operation of step S30, the user has inputted the file name of the second document data as “Document 1_new.doc” in the box 101 through the operation unit 15, and pressed the key 102. When the touch panel 15A detects that the key 102 has been pressed, the controller 10 decides that an instruction to fix the file name of the second document data has been inputted (YES at step S30), and stores the second document data with the file name thereof inputted in the box 101, in the HDD 19 (step S31).

When the user presses the key 102 without changing the file name shown in the box 101 as default, the controller 10 overwrites the second document data on the first document data, and stores the second document data in the HDD 19.

Now, when a document is to be printed with an image forming apparatus on the basis of document data, the user may notice that the document contains a misspelling. In such a case, the user has to move from the location of the image forming apparatus to the location of a personal computer, and correct the misspelling in the document data using the personal computer, which is both troublesome and time-consuming.

With the existing techniques, only the preview image is displayed before the printing is executed. Therefore, the mentioned drawback is unable to be solved.

According to the foregoing embodiment, in contrast, the controller 10 causes the display unit 16 to display, when the first document data is received through the interface unit 21, and the character strings expressed by the first document data include the first character string containing the misspelling, the second character string that may possibly be substituted for the first character string. The controller 10 also generates, upon receipt of the instruction to select the second character string through the operation unit 15, and on the basis of the first document data, the second document data in which the first character string in the character strings expressed by the first document data is substituted with the second character string selected, and causes the image forming unit 12 to form the image based on the second document data, on the recording sheet.

As described above, the user can make out the second document data, simply by inputting the instruction to select the second character string that may possibly be substituted, through the operation unit 15. Therefore, the time required for the user to move from the location of the image forming apparatus 1 to the location of PC 23, and the trouble of correcting the misspelling in the document data using the PC 23, can both be saved.

According to the foregoing embodiment, the controller 10 causes the display unit 16 to display a plurality of second character strings. The controller 10 generates the second document data, upon receipt of the instruction to select one of the plurality of second character strings, through the operation unit 15.

Therefore, the user can select the second character string to be substituted for the first character string, out of the plurality of second character strings displayed as possible substitutes, which leads to further improvement in user-friendliness.

According to the foregoing embodiment, the controller 10 causes the display unit 16 to display the plurality of second character strings in the order of similarity to the first character string, which further facilitates the user to select the second character string to be substituted for the first character string. Therefore, the user-friendliness can be further improved.

According to the foregoing embodiment, the controller 10 causes the display unit 16 to display the second character string highest in similarity to the first character string, in a different form from the remaining second character strings. This arrangement further facilitates the user to select the second character string having the highest similarity to the first character string, thereby further improving the user-friendliness.

According to the foregoing embodiment, the controller 10 causes the display unit 16 to display the second character string together with the first character string, thereby allowing the user to select the second character string, upon confirming the first character string. Therefore, the user-friendliness can be further improved.

According to the foregoing embodiment, the controller 10 stores the second document data in the HDD 19, or in the USB memory connected to the interface unit 21, upon receipt of the instruction to save the second document data, through the operation unit 15. This arrangement facilitates the user to acquire the second document data, thereby further improving the user-friendliness.

### Variations

Although a plurality of second character strings are displayed on the display unit 16 as possible substitutes for the first character string in the foregoing embodiment, the disclosure is not limited to such an arrangement. For example, only one second character string highest in similarity to the first character string may be displayed, as a possible substitute for the first character string.

In the foregoing embodiment, the controller 10 causes the display unit 16 to display the second character string highest in similarity to the first character string in the correction screen 70, in a different color from the remaining second character strings. However, the disclosure is not limited to such an arrangement. For example, the controller 10 may cause the display unit 16 to display the second character string in other display forms, for example in bold letters, in the Italic type, and with an underline, for distinction from the remaining character strings.

Although the controller 10 causes the display unit 16 to display the plurality of second character strings in the order of similarity to the first character string in the foregoing embodiment, the disclosure is not limited to such an arrangement. For example, the controller 10 may cause the display unit 16 to display the plurality of second character strings in the order of dissimilarity from the first character string.

Further, the plurality of second character strings may be aligned in the order of different criteria, without limitation to the similarity to the first character string. For example, the controller 10 may cause the display unit 16 to display the plurality of second character strings in the order of likelihood of being selected by the user, either in ascending or descending order, on the basis of the context or intent of the character strings expressed by the first document data.

Although the first document data and the second document data are saved in the format of Microsoft Word (registered trademark) in the foregoing embodiment, the disclosure is not limited to such an arrangement. The document data may be saved, for example, in a text format, a single file web page format, or a portable document format (PDF).

Although the external storage device is exemplified by the USB memory in the foregoing embodiment, different storage devices may be adopted. It suffices that the external storage device is a portable, non-volatile recording medium. For example, an SD card, a ROM, and a flash memory may be employed. In this case, the interface unit 21 is configured so as to be compatible with such external storage devices.

Further, although the image forming unit 12 is configured to form an image on a recording sheet in the foregoing embodiment, the disclosure is not limited to such an arrangement. The image forming unit 12 may form an image on a different recording medium, without limitation to the recording sheet. For example, an overhead projector (OHP) sheet may be utilized. In addition, the controller 10 may only be configured to generate the second document data, without the function to cause the image forming unit 12 to form an image based on the second document data, which also constitutes an embodiment of the disclosure.

The disclosure is not limited to the foregoing embodiment, but may be modified in various manners. For example, although the image forming apparatus according to the disclosure is exemplified by a color multifunction peripheral in the foregoing embodiment, the disclosure is broadly applicable to a monochrome multifunction peripheral or other types of electronic apparatuses, including other types of or other types of image forming apparatuses such as a printer, a copier, and a facsimile machine.

The configurations and arrangements according to the foregoing embodiment, described with reference to FIG. 1 to FIG. 10, are merely exemplary, and in no way intended to limit the disclosure to those configurations and arrangements.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
a data input unit that receives an input of first document data;
an instruction input unit that receives an instruction inputted by a user;
an image forming unit that forms an image on a recording medium;
a display unit; and
a controller including a processor, and configured to decide, when the processor executes a correction control program, whether character strings expressed by the first document data, received through the data input unit, include a first character string containing a misspelling,
the controller being further configured to:
cause the display unit to display, when the first document data is received through the data input unit, and the character strings expressed by the first document data include the first character string containing the misspelling, a second character string that may possibly be substituted for the first character string; and
generate, upon receipt of an instruction to select the second character string through the instruction input unit, second document data on a basis of the first document data, by substituting the first character string in the character strings expressed by the first document data, with the second character string selected.

2. The image forming apparatus according to claim 1,
wherein the controller causes the image forming unit to form an image based on the second document data, on the recording medium.

3. The image forming apparatus according to claim 1,
wherein the controller is configured to:
cause the display unit to display a plurality of the second character strings; and
generate the second document data, upon receipt of an instruction to select one of the plurality of second character strings, through the instruction input unit.

4. The image forming apparatus according to claim 3,
wherein the controller causes the display unit to display the plurality of second character strings, in order of similarity to the first character string.

5. The image forming apparatus according to claim 3,
wherein the controller causes the display unit to display the second character string highest in similarity to the first character string, in a different display form from the remaining second character strings.

6. The image forming apparatus according to claim 1,
wherein the controller causes the display unit to display the first character string together with the second character string.

7. The image forming apparatus according to claim 1, further comprising a storage unit,
wherein the controller stores the second document data in the storage unit, upon receipt of an instruction to save the second document data, through the instruction input unit.

8. The image forming apparatus according to claim 1,
wherein the controller causes the image forming unit to form an image based on the first document data on the recording medium, when the character strings expressed by the first document data are without the first character string.

9. The image forming apparatus according to claim 1,
wherein the controller is configured to:
cause the display unit to display a screen for selecting whether to correct the misspelling, when the character strings expressed by the first document data include the first character string;
cause the display unit to display the second character string, upon receipt of an instruction to correct the misspelling, through the instruction input unit; and
cause the image forming unit to form an image based on the first document data on the recording medium, upon receipt of an instruction to leave the misspelling uncorrected, through the instruction input unit.
